(19) United States
(12) Patent Application Publication
(10) Pub. No.: US 2002/0156584 A1
(43) Pub. Date: Oct. 24, 2002

(54) Insect collection and test

(76) Inventors: Brian M. Sullivan, Redondo Beach, CA (US); Denes L. Zsolnay, Rolling Hills Estates, CA (US)

Correspondence Address: Patent Counsel, TRW Inc., S&EG Law Department, E2/6051, One Space Park, Redondo Beach, CA, 90278, US

(21) Appl. No.: 09/838,625

(22) Filed: Apr. 19, 2001

(51) Int. Cl. G06F 19/00

(52) U.S. Cl. 702/19

(57) ABSTRACT

Fast, safe and effective monitoring of the presence of (and/or spread of) a virus or other disease causing agent is obtained by a computer controlled test unit (1, 3) that automatically collects and tests flying insects in the environment, such as mosquitoes, for the presence of disease causing virus. Responding to bait (11) furnished in the front end (3) of the unit, mosquitoes are attracted and drawn into an air stream, generated by a fan (9), that forces the mosquitoes into a detergent solution reservoir within a chamber (17). The mosquitoes drown in the solution and the detergent solution leaches any virus carried by the mosquito from the mosquito carcass. After a suitable lapse of time necessary to collect mosquito specimens, the detergent solution is automatically pumped (19) into the automated enzyme linked immunosorbent assay (“ELISA”) device portion (1) of the unit and the results of the ELISA are displayed.

### CROSS REFERENCE TO RELATED APPLICATIONS

Applicant claims the benefit provided by 35 U.S.C. 120 based on copending application serial no. (TRW Docket No. 38-0010), filed concurrently herewith, entitled “Automated Computer Controlled Reporter Device for Conducting Imunnoassay and Molecular Biology Procedures”.

### FIELD OF THE INVENTION

This invention relates to the public health and safety and, more particularly, to automated detection and identification of disease causing biological agents, such as virus, carried by airborne vectors found in the environment.

### BACKGROUND

Communicable disease is egalitarian in nature, affecting rich and poor alike. Beyond the scope of an individual to handle, customarily citizens look to government to monitor the environment for outbreak of disease, to warn the citizenry of an impending epidemic and tender guidance for one to minimize the spread of any contagion to one's person or to others, provide access to vaccines that immunize the person to the disease and medicines to cure those afflicted, and to trace and eliminate the conditions that lead to the disease. As an appropriate but unglamorous governmental function, and whether out of concern for its citizens or in its own interest in protecting its infrastructure of public servants and officials and the vigor of its armed forces, governments have undertaken the principal responsibility for meeting the foregoing needs. In the United States, the public health services of the states and counties and, nationally, the Centers for Disease Control and Prevention are critical organizations in the foregoing efforts. Unfortunately the degree of diligence with which the government pursues the foregoing effort is mixed, sometimes dulled by overconfidence and may fall short.

As an unwelcome side effect of the “globalization” of commerce, and the increase in and faster pace of air travel that accompanied that globalization, a virus endemic to one continent may move quickly to another continent, where the virus may be virtually unknown to most medical personnel. As an example one notes the recent outbreak of the West Nile Virus in New York City that was virtually unknown in the city. One expects government to anticipate and protect against such unwelcome events, and, following the death of a small number of citizens from the virus, the response was quick. As a response to the West Nile Virus outbreak, health officials concluded that mosquitoes and birds should be tested widely as a precautionary public health measure. The officials suggested that the public health authorities (and citizens) should be on the lookout for dead crows found in the Eastern states as indicia of disease. Many officials also supported more sophisticated (and more expensive) ways to track the spread of a virus, specifically maintaining flocks of chickens and testing the blood of the chickens regularly for the virus. The disease carrying mosquitoes (the “vectors”) infect the chickens with the virus and the chickens in turn incubate the virus to more easily detected levels.

Twenty years ago most states maintained such “sentinel flocks” to monitor impending outbreaks of the Saint Louis Encephalitis and several other types of mosquito-borne encephalitis. Due to budget cutbacks, perhaps coupled with overconfidence, most of those sentinel flocks have since disappeared along with the expertise required to maintain them. To reinstate those flocks on short notice is very difficult. A Yale University medical entomologist has noted that the state infrastructures have crumbled to all time lows. Even if the sentinel flocks could be restored, the flocks might not be welcome where they are most needed. Quoting from Science, vol. 286, pp 1450-51 (Nov. 19, 1999): “It would be difficult to install a hen house on Wall Street”.

Mosquitoes may be examined directly and laboratory techniques are available to permit the direct test of individual mosquitoes for the virus, but performing those tests is not easy. Those techniques are not widely used because they require a level of skill typically unavailable in state and local laboratories. As example, one such laboratory testing technique is an enzyme linked immunosorbent assay (“ELISA”). That assay is a quantitative in vitro test for an antibody or antigen in which the test material is adsorbed on a surface and exposed to a complex of an enzyme linked to an antibody specific for the substance being tested for with a positive result indicated by a treatment yielding a color in proportion to the amount of antigen or antibody in the test material. More recently the foregoing definition has been expanded to include yielding a rate of change of current conductivity in proportion to the amount of antigen or antibody in the test material.

The ELISA procedure is described more specifically, for one, in a book entitled Methods in Molecular Biology Vol 42, John R. Crowther, Humana Press, 1995 and also, as a more recent development, in Patent Cooperation Treaty application no. PCT/US98/16714, filed Aug. 12, 1998 (International Publication No. WO 99/07870), entitled “Electrochemical Reporter System for Detecting Analytical Immunoassay and Molecular Biology Procedures” (hereafter the “'16714 PCT application”). The 16714 PCT application describes both a colormetric and an electrochemical reporter system for detecting and quantifying enzymes and other bioagents in analytical and clinical applications.

Accordingly, an object of the present invention is to simplify the hunt for viruses in the environment.

Another object of the invention is to provide an easy to operate system that automatically acquires and tests airborne vectors for incidence of specific viruses.

A further object of the invention is to provide a monitor and test apparatus that may be operated by relatively unskilled personnel and is not restricted to use within a laboratory.

A recent innovation automates the ELISA (and ELISA-like) procedure described in the foregoing background to this specification, and provides a self-contained easy to operate system that may be operated by relatively unskilled personnel and capable of use outside the laboratory. Controlled by a programmed microprocessor and stocked with appropriate ingredient fluids the apparatus automatically checks for a specific bio-agent in a sample placed in the apparatus and, if present, displays the concentration of that bio-agent. That automated ELISA apparatus is illustrated and described in patent application to Sullivan et al., Serial No. (TRW Docket No. 38-0010), filed concurrently herewith, (the “Sullivan application”), which is incorporated herein in its entirety, including both specification and drawings. As an advantage, the foregoing automated apparatus is adapted within the present invention.

### SUMMARY OF THE INVENTION

In accordance with the foregoing objects and advantages, fast, safe and effective monitoring of the spread of virus is obtained by an automated unit that automatically collects and tests flying insects in the environment, such as mosquitoes, for the presence of disease causing virus. Responding to bait furnished in the front end of the unit, mosquitoes are attracted and drawn into an airstream generated by a fan that forces the mosquitoes into a detergent solution reservoir within a chamber. The mosquitoes drown in the solution and any virus carried by the mosquito is leached from the carcass into the detergent solution. The detergent solution is automatically pumped into the automated enzyme linked immunosorbent assay (“ELISA”) device portion of the unit and the results of the ELISA are displayed.

As an advantage the invention is microprocessor controlled, effectively placing the high technical skills required for an ELISA procedure within the program of the microprocessor and eliminating the need for the operator to posses those skills. The invention may be operated and maintained by relatively unskilled personnel. Because of that advantage the invention may be widely distributed with clearly marked supplies for deployment by ordinary persons and does not impose an intervention requirement by the relatively few trained microbiologists.

The foregoing and additional objects and advantages of the invention, together with the structure characteristic thereof, which were only briefly summarized in the foregoing passages, will become more apparent to those skilled in the art upon reading the detailed description of a preferred embodiment of the invention, which follows in this specification, taken together with the illustrations thereof presented in the accompanying drawings.

### BRIEF DESCRIPTION OF THE DRAWINGS

In the drawings:

FIG. 1 illustrates an embodiment of the invention; and

FIG. 2 illustrates an alternative embodiment of the invention.

### DETAILED DESCRIPTION OF THE PREFERRED EMBODIMENTS

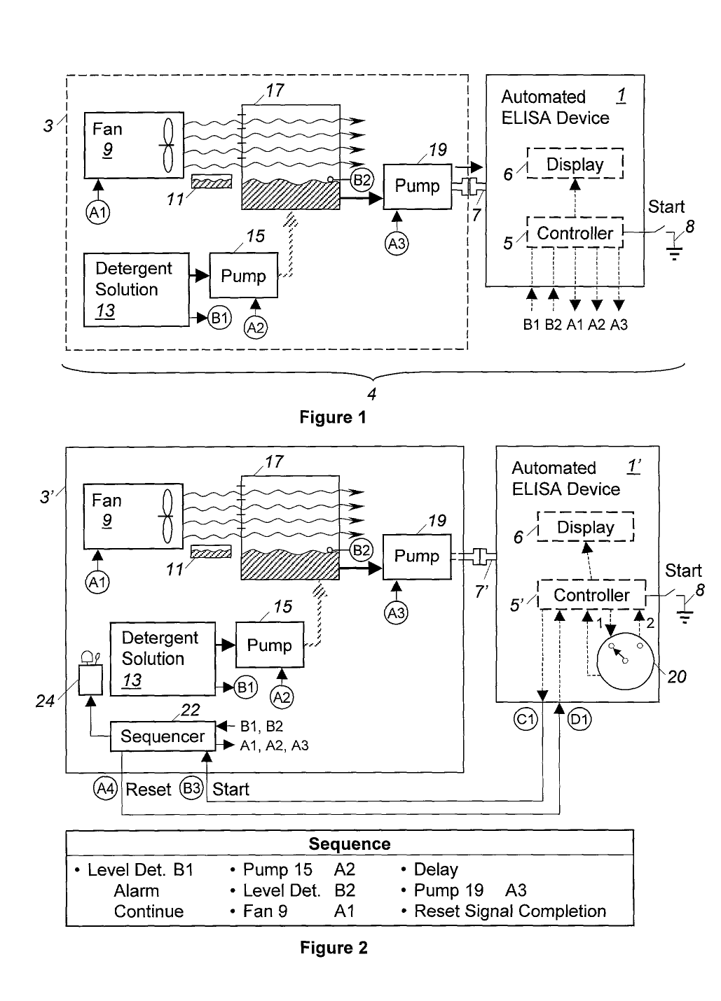

Reference is made to FIG. 1 illustrating a preferred embodiment of the insect testing apparatus. The apparatus includes the structure of the automated ELISA apparatus 1, illustrated in block form, and the additional structure illustrated in the dash line block 3, the “front end”, which, suitably, are mounted together in a single housing, as represented by bracket 4, but not otherwise illustrated. The internal structure of apparatus 1 is essentially as described and illustrated in the Sullivan application to which reference may be made for additional details that need not be here repeated.

In brief, the apparatus disclosed in the Sullivan application is an automated computer-controlled tester for performing assessments of immunologic and molecular biology molecules, namely ELISA and ELISA-like assays, in accordance with the steps prescribed by the program of the computer and displays the results obtained on a display for the operator to view. An electronic controller includes a programmed microprocessor, eg. the computer, generally represented as controller 5. The foregoing apparatus accepts a sample that may contain a suspect bioagent or the like that is mixed in liquid to form a sample solution and automatically treats the sample solution with recognition molecules and reporter molecules in a prescribed sequence to produce an electrical signal at a sensor, automatically inspects the results obtained from the signal over a short interval, processes those results to obtain a number, the slope, that represents the concentration of the suspect bioagent or the like in the solution, and displays the result on a display 6, such as one of the liquid crystal type, etc., or reports it over some data collection system.

It is recognized that the prior apparatus of the Sullivan application is general purpose in application, and, to incorporate the foregoing apparatus as part of the present invention, some minor modifications are necessary. For example, a fluid conduit 7 is added between front end 3 that couples into the sample vessel or reservoir, not illustrated, inside apparatus 1; appropriate electrical cables, not illustrated, for coupling electricity to the front end are included; a number of inputs B1 and B2 to the controller and a number of controlled outputs A1, A2 and A3 are added to the controller to interface with front end 3 and electrical cabling, not illustrated, is included to for making the connection with those inputs and outputs. Lastly, the program of controller 5 is changed to accommodate the additional inputs and outputs of the controller and to control the operation of front end 3. The function and purpose of such modifications is more easily understood from the description of operation later herein described.

Front end 3 contains an electrically operated fan 9, a device to hold mosquito bait 11, a reservoir or container of detergent solution 13, electrical pump 15, a open chamber 17 containing a pan, the reservoir, to hold a detergent solution in which to deposit mosquitoes, and a second electric pump 19. Detergent container 13 includes a level sensor, not illustrated, which supplies controller 5 with information of the detergent level remaining in the container via an input B1 to the controller. Likewise the reservoir in chamber 17 includes another level sensor, not illustrated, that supplies the controller with information of the level of solution in the reservoir. That information is supplied to the controller via input B2 to the controller.

For operation the testing unit is set up in the locale that is to be monitored for the mosquitoes and the unit is connected to or powered up either using an internal battery pack or an external source of electricity. The various reservoirs fluid reservoirs are checked to ensure that the appropriate fluids are in place in apparatus 1 and in front end unit 3 and are at the desired level. Stagnant water, the bait to attract mosquitoes, is placed in pan 11. If stagnant water is unavailable, an electric black light lamp may be substituted and connected to the source of electricity available in apparatus 1.

When ready, the operator operates start switch 8 and tester unit 1 commences operation under control of computerized controller 5 contained within apparatus 1. Among other initialization steps prescribed by the controller program the controller checks input B1 from front end 3 to check the fluid level in container 13. If the fluid levels are found insufficient the controller displays or sounds an alarm, not illustrated, to call the operator to correct the insufficiency and halts further operation until the fluid levels are corrected.

Assuming fluid levels in storage container 13 are sufficient (or replenished, if earlier found below the desired level, and the operation restarted), the controller energizes pump 15 via output A2. Pump 15 pumps detergent solution from the container and into the pan or reservoir in chamber 17, filling up the pan to the requisite level. The level monitor, not illustrated, located in chamber 17 outputs information of the fluid level of the detergent solution to controller 5 via output B2. Once the controller determines that the detergent level is of the required level, the controller de-energizes pump 19. Concurrently or following de-energization of pump 15, the controller energizes fan 9 via output A1, and maintains the fan energized for a predetermined period, such as one or two hours, thought sufficient to attract and gather mosquitoes. The fan creates an airstream that blows across the mosquito bait in pan 11 and into chamber 17.

Stagnant water (and black lighting) is attractive to mosquitoes, and particularly to female mosquitoes, which by nature view stagnant water as an excellent place to lay eggs. Female mosquitoes are more desirable for testing since, typically, the female mosquito carries the virus in the gut of the mosquito. Being attracted to the bait, mosquitoes fly toward the bait and are intercepted and caught up in the air stream. Being sufficiently forceful, the airstream pushes such mosquitoes through the open front entry of chamber 17 and into the detergent solution in the reservoir of the chamber in which the mosquito drowns. Acting on the mosquito carcass, the detergent solution, as is known, dissolves or leaches out the stomach contents of the mosquito's gut, which includes any virus in the gut. Those contents of the guts are accumulated in the detergent solution inside chamber 17.

After a sufficient time has elapsed during which a good number of mosquitoes have ideally been disposed of or collected by the apparatus in chamber 17, typically one or two hours as example, controller 5 terminates operation of fan 9, and energizes pump 19 via output A3. Pump 19 pumps the contaminated detergent solution from chamber 17 and, via fluid conduit 7, pumps the solution into test apparatus 1, where the solution is placed in the sample reservoir of the test apparatus.

Apparatus 1 automatically acts upon the foregoing sample in the manner described in the copending Sullivan et. al. application, which need not be repeated here in full. Briefly, apparatus 1 automatically performs an ELISA procedure on the sample. If the sample contains the virus being sought, eg. the suspect virus, the apparatus produces a display of the concentration of that virus on display 6, records the result for later examination. Alternatively, the apparatus provides an indication or signal that remotely alerts the testing organization. This concludes the testing procedure.

As one might expect, insects other than mosquitoes may be drawn into the front end during the insect collection period. As an example, where the black lighting is employed as the bait, moths may be attracted, collected and dissolved or leached in the same way as described for the mosquitoes. However, the moths do not carry the virus being sought; only the mosquito carries the virus. Hence, any moth carcasses or carcasses of other insects as may be drawn into the system are essentially neutral, and should not affect the outcome of the ELISA testing.

Large insects, such as moths, may however cause premature filling of the chamber. If that occurs the foregoing apparatus may be modified to include a filter. As example, a screen may be located in front of chamber 17. The screen may contain holes large enough to permit mosquitoes to pass through, but that are too small to permit moths to pass through. Should such a filter be employed, from time to time it will be necessary to clean the filter.

If for any reason one desires an alternate embodiment in which insects are ground up prior to immersion in a liquid solution in chamber 17, front end 3 may be modified to accommodate such a feature. As example an electrically operated grinder comprising a pair of cylindrical rollers that are rotated at different speeds in the same rotational direction will produce a grinding action on the body of an insect pushed into the griping side of the rotating rollers. The rollers tear the carcass apart producing a paste like debris. Such a grinder may be placed between the bait 11 and the entry to chamber 17 with the airstream directed to the input side of the grinder and with the output side of the grinder arranged to expel the debris through the entry to chamber 17, where the debris accumulates in the solution. For such an embodiment, it is not necessary for the solution in container 13 to hold a detergent solution. Instead an alternative solution may be used. With the ground insects collected in the reservoir inside chamber 17, the operation of the apparatus continues as previously described.

The foregoing insect collector and tester is a self-contained stand alone unit that contains all of the means to collect and test insects for a specific virus. In essence the apparatus is a special purpose apparatus. As those skilled in the art appreciate, in lieu of a special purpose apparatus, the foregoing may be constructed in two parts, the apparatus 1 constituting a general purpose automatic ELISA device and the front end 3 constituting an “add-on” unit. Such an alternative embodiment is illustrated in FIG. 2 to which reference is made. To aid in understanding the embodiment, those elements in FIG. 2 which may be identical to an element used in the embodiment of FIG. 1 are identified by the same number and those elements which are substantially the same as, but not identical to an element in the prior embodiment are identified by the same number primed.

To minimize modification of the general automated ELISA device 1′ for use in this embodiment, the general purpose automated ELISA device in the embodiment of FIG. 2 is modified to include a selector switch 20, an additional output C1 and an additional input D1. Inputs B1, B2 and Outputs A1, A2 and A3 that were used in the embodiment of FIG. 1 are not included in controller 5′ and are excluded from the program of the controller. Selector switch enables automated ELISA device 1′ to be switched from the general purpose application, when the switch is set to position “1”, wherein the ELISA device is operated in accordance with the description of the copending earlier filed application to the special purpose application in which the front end 3′ is attached to the foregoing automated unit as a peripheral or “add-on” device. When the automated ELISA device is to be used with the front end 3′, selector switch 20 is set to position “2”. The program used in the controller 5 of the embodiment of FIG. 1 is modified for this embodiment to include a check of the position of switch 20 during program initialization. With the selector set in position “2” the program of controller 5′, which checks all of the switch settings (and inputs and outputs) during program initialization, is able to determine that the program of the controller is to operate in conjunction with front end 3′.

Front end 3′ in this embodiment includes a sequencer 22. The sequencer is an electronic sequencing device, such as a state machine or may be a progammed microprocessor. The sequencer provides the outputs A1, A2 and A3 at the appropriate times or place in the sequence of operation, indicated in the sequence chart in the figure to operate pump 15, fan 9 and pump 19. Sequencer contains a start input B3 connected to output C1 of controller 5′ and a reset output A4 that is coupled to input D1 of that controller. The sequencer also includes a timing circuit, not illustrated, that prescribes a predetermined time interval, later herein described, an alarm 24 and a logic circuit, not illustrated, for energizing the alarm should the input at B1 indicate a problem with the fluid level in vessel 13. As becomes apparent from the description of operation, the sequencer 22 takes over many of the functions of controller 5′ in the automated ELISA device 1′, relieving the controller of those duties, whereas in the prior embodiment, all of the functions performed by the front end where directly initiated by the associated controller.

For this embodiment, the program of controller 5 of the prior embodiment is further modified to energize output C1 at the start of operation, once the program determined that selector switch is set to position “2”, and then halt further operation of ELISA device 1′ unit an input is provided by the front end 3′ to input D1. After the input is received at D1, signifying the completion of the tasks of sequencer 22, including the pumping of the sample through conduit 7′ into automated ELISA device 1′, controller 5′ resumes the automated test procedure, earlier described.

The output at C1 effectively transfers control of operation over to sequencer 22 in front-end 3′. Sequencer 22 performs the operation presented in the Sequence chart in FIG. 2. The sequencer sequences through the initialization of the detergent fluid level in vessel 13 through a check of the fluid level sensor output at B1. If the level is low, logic circuits not illustrated in the sequencer initiates operation of alarm 24, and resets, halting the entire operation and requiring the operation to be restarted, once the supply of detergent is replenished. Assuming the fluid level is sufficient, the sequencer continues with pumping of the detergent solution into chamber 17 by providing an output at A2 to pump 15, and then commences operation of fan 9′ by providing the output at A1 to energize the fan. The sequencer also initiates operation of an internal timing circuit, and then waits for the lapse of a predetermined time-out period measured from fan initiation set in the timing circuit. Following expiration of that period, through supplying an output A3 to pump 19, the virus loaded detergent solution from the chamber 17 is pumped via conduit 7′ into ELISA apparatus 1′.

With the foregoing functions accomplished sequencer 22 places a signal on input D1 to notify the automated ELISA device 1′ to take over operation, and the sequencer resets, awaiting a further input to B3. Once the program of controller 5′ detects the input at D1, the controller commences the automated ELISA operation, earlier described, as may culminate with a display of the concentration of the virus being sought.

As one appreciates the foregoing insect collection and test operation does not requires the operator to possess a great degree of skill. Training appears minimal. The unit is of a character that enables the unit to be distributed with supplies to ordinary citizens throughout a country or region. Those citizens may be called upon to set up and monitor a region near their homes or businesses and report the results of the testing to a government agency. The government then quickly gains vital information on the whereabouts of and spread of a specified insect borne virus, e.g., Dengue fever which is spread by mosquitoes. Likewise in the course of a military operation in which the enemy is reputed to possess a dangerous bioagent, the soldiers may quickly set up the foregoing units to “look” for that bioagent. Only if such bioagent is found do the soldiers need to take the extra precautions needed to prevent infections, such as taking vaccinations or wearing special protective clothing and headgear that is hot and heavy.

It is believed that the foregoing description of the preferred embodiments of the invention is sufficient in detail to enable one skilled in the art to make and use the invention without undue experimentation. However, it is expressly understood that the detail of the elements comprising the foregoing embodiments presented to fulfil the foregoing purpose is not intended to limit the scope of the invention in any way, in as much as equivalents to those elements and other modifications thereof, all of which come within the scope of the invention, will become apparent to those skilled in the art upon reading this specification. Thus, the invention is to be broadly construed within the full scope of the appended claims.

What is claimed is:

1. Apparatus for detecting a virus carried by insects, comprising:
collecting means for automatically collecting and storing insects in a liquid solution, wherein any virus carried by said insects is transferred to said liquid solution; said collecting means being open to the surrounding environment to permit entry of said insects; and
testing means for automatically testing the liquid solution for the presence of said virus.

2. The apparatus for detecting a virus as defined in claim 1, wherein said testing means includes a display for indicating the presence of a virus.

3. The apparatus for detecting a virus as defined in claim 1, wherein said testing means further includes means for determining the concentration of said virus contained in said liquid solution and a display for indicating said concentration.

4. The apparatus for detecting a virus as defined in claim 1, wherein said collecting means comprises:
a chamber, said chamber having an air inlet, an air outlet and a reservoir holding a liquid solution;
insect bait for attracting insects, said insect bait being positioned in front of said air inlet;
an electric fan for producing an airstream that is directed over said insect bait and into said air inlet, whereby insects entering into said airstream are pushed into said chamber and into said liquid solution in which the insects drown;
an electric pump for pumping, when energized, said liquid solution from said reservoir in said chamber into said testing means.

5. The apparatus for detecting a virus as defined in claim 4, wherein said collecting means further comprises:
a vessel containing liquid solution; and
a second electric pump for pumping said liquid solution, when energized, from said vessel and into said chamber.

6. The apparatus for detecting a virus as defined in claim 5, wherein said liquid solution comprises a detergent solution.

7. The apparatus for detecting a virus as defined in claim 6, wherein said testing means comprises an automated enzyme linked immunosorbent assay (“ELISA”) device.

8. The apparatus for detecting a virus as defined in claim 7, wherein said testing means further includes a controller; and wherein said controller includes:
means for energizing said second electric pump until said reservoir in said chamber is filled to a predetermined level with detergent solution;
means for energizing said electric fan for a predetermined period of time after said reservoir in said chamber is filled; and
means for energizing said electric pump following said predetermined period of time for pumping said liquid solution from said reservoir in said chamber into said testing means.

9. Apparatus for detecting a virus carried by insects, comprising:
an electronic controller, including a programmed microprocessor;
collecting means for automatically collecting and storing insects in a liquid solution responsive to initiation by said electronic controller, wherein any virus carried by said insects is transferred to said liquid solution; said collecting means being open to the surrounding environment to permit entry of said insects; and
testing means controlled by said electronic controller for automatically testing said liquid solution for the presence of said virus.

10. The apparatus for detecting a virus carried by insects as defined in claim 9, further comprising: transfer means for transfering at least a portion of said liquid solution from said collecting means to said testing means.

11. The apparatus for detecting a virus carried by insects as defined in claim 9, wherein said collecting means comprises:
bait for attracting insects;
an airstream generator for producing an airstream for a predetermined period of time, said airstream generator being initiated by said electronic controller;
a chamber, said chamber having an entry for receiving said air stream and a reservoir for holding a liquid solution;
said airstream being directed over said bait to intercept any insects flying toward said bait and force said insects through said entry to said chamber and into said liquid solution in said reservoir, whereby said insects drown in said liquid solution.

12. The apparatus for detecting a virus carried by insects as defined in claim 11, further comprising: transfer means for transferring at least a portion of said liquid solution from said collecting means to said testing means.

13. The apparatus for detecting a virus carried by insects as defined in claim 12, wherein said transfer means comprises an electric pump.

14. The apparatus for detecting a virus carried by insects as defined in claim 13, wherein said liquid solution comprises a detergent solution, said detergent solution being capable of leaching virus and other substances in insects disposed in said liquid solution.

15. The apparatus for detecting a virus carried by insects as defined in claim 14, wherein said collection means further comprises:
a vessel for storing liquid solution;
a second electric pump, said second electric pump being connected between said vessel and said reservoir of said chamber for pumping liquid fluid from said vessel into said reservoir.

16. The apparatus for detecting a virus carried by insects as defined in claim 15, wherein said program of said microprocessor includes:
means for initiating operation of said airstream generator for a predetermined period of time;
means responsive to the lapse of said predetermined period of time for initiating operation of said electric pump, whereby fluid solution is pumped into said testing means; and
means for initiating operation of said testing means.

17. The apparatus for detecting a virus carried by insects as defined in claim 16, further comprising:
level monitoring means for monitoring the level of liquid solution in said reservoir of said chamber; and wherein said program of said microprocessor further includes:
means for checking said level monitoring means to determine if said level is at a predetermined level;
means for initiating operation of said second electric pump when said level is below said predetermined level, and continuing operation of said second electric pump until said level attains said predetermined level.

18. The apparatus for detecting a virus carried by insects as defined in claim 15, wherein said collecting means further includes:
sequencing means for energizing in sequence said airstream generator for a predetermined time period and energizing said electric pump responsive to initiation by said electronic controller;
said sequencing means including means for signaling said electronic controller of the completion of pumping by said electric pump;
said electronic controller being responsive to said signal from said sequencing means for initiating operation of said testing means.
